(19) United States
(12) Patent Application Publication
(10) Pub. No.: US 2007/0091534 A1
(43) Pub. Date: Apr. 26, 2007

(54) CONTROL CIRCUIT FOR RELAY

(75) Inventor: MING-CHIH HSIEH, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,628

(22) Filed: Sep. 1, 2006

(30) Foreign Application Priority Data
Oct. 21, 2005 (CN) 200510100575.1

(51) Int. Cl. H01H 47/00

(52) U.S. Cl. 361/160

(57) ABSTRACT

An exemplary control circuit for a relay includes a diode and a transistor. The diode has an anode acting as an input of the control circuit receiving a control signal, and a cathode is connected to a base of the transistor via a first resistor. A collector of the transistor is connected to an end of the relay, another end of the relay is connected to a power supply via a second resistor, and an emitter of the transistor is grounded.

### DESCRIPTION

1. Field of the Invention

The present invention relates to a control circuit for a relay, and particularly to a control circuit which uses RS232 logic levels to control a relay.

2. Description of Related Art

With the rapid development of communication technologies, the Electronic Industries Alliance (EIA) and the Telecommunications Industry Association (TIA) have developed a series of standards to simplify data communication. The RS232 standard is well known in the art, which can recognize voltage signal levels ranging from −12V to +12V. However, other voltage signal levels that are different from the voltage signal levels of the RS232 are also widely used in the electronics and telecommunication industries. In typical devices, most logic signal families utilize narrower and single-direction voltage signal levels. One of such logic signal families is the transistor-transistor-logic (TTL) signal family, which recognizes voltage signal levels ranging from 0V to +5V. Most relays use TTL voltage signals as the control signals.

Because the voltage ranges of the RS232 voltage signals are different from that of the TTL voltage signals, relays supporting the TTL standard can not utilize the RS232 voltage signals directly.

Generally, devices for translating voltage signal levels are level translation ICs (Integrated Circuits). Level translation ICs can facilitate communication between RS232 devices and TTL devices. A conventional level translation IC requires two power sources. One power source ranges from 0V to +5V in order to communicate with the TTL device, and the other power source ranges from 0V to +12V in order to communicate with the RS232 devices.

Although the level translation IC can implement bidirectional level translations between the TTL voltage signal levels and the RS232 voltage signal levels, the level translation IC has some disadvantages. The price of a typical level translation IC is high. In addition, the level translation ICs must be connected to the power supplies of both the RS232 devices and the TTL devices in order to translate voltage signal levels.

What is needed is to provide a control circuit which can be implemented in the place of a translation IC and has a simple structure and low cost.

### SUMMARY OF THE INVENTION

An exemplary control circuit for a relay includes a diode and a transistor. The diode has an anode acting as an input of the control circuit receiving a control signal, and a cathode is connected to a base of the transistor via a first resistor. A collector of the transistor is connected to an end of the relay, another end of the relay is connected to a power supply via a second resistor, and an emitter of the transistor is grounded.

Other advantages and novel features of the invention will become more apparent from the following detailed description when taken in conjunction with the accompanying drawings, in which:

### BRIEF DESCRIPTION OF THE DRAWINGS

FIG. 1 is a circuit diagram of a control circuit for a relay in accordance with a preferred embodiment of the present invention.

### DETAILED DESCRIPTION OF THE INVENTION

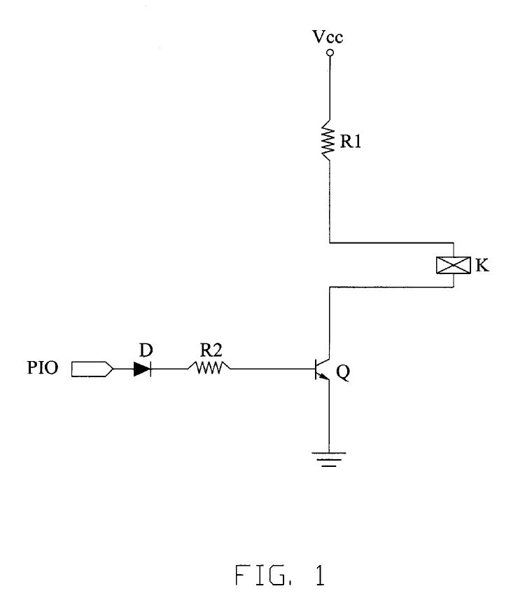

Referring to FIG. 1, a control circuit for a relay in accordance with a preferred embodiment of the present invention includes a power supply Vcc, a first resistor R1, a second resistor R2, a transistor Q, a diode D, and an input PIO. The power supply Vcc is connected to one end of a relay K via the first resistor R1. A collector of the transistor Q is connected to another end of the relay K. An emitter of the transistor Q is grounded. The input PIO is connected to an anode of the diode D, a cathode of the diode D is connected to a base of the transistor via the second resistor R2. The input PIO receives a RS232 voltage signals.

In operation, when a voltage at the input PIO is at a high level, for example +12V, the diode D is turned on, the transistor Q is also turned on, and the relay K starts to work. When the voltage at the input PIO is at a low level, for example −12V, the diode D is turned off, and because the diode D allows current to flow in one direction but not the other, the transistor Q is turned off, and the relay K stops working. The RS232 voltage signals control the relay K using the control circuit for driving transistor-transistor-logic (TTL) devices, and the control circuit has a simple structure and low cost.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. A control circuit for a relay, comprising:
a diode having an anode and a cathode, the anode of the diode acting as an input for receiving a control signal; and
a transistor, a base of the transistor connected to the cathode of the diode via a first resistor, a collector of the transistor connected to an end of the relay, another end of the relay connected to a power supply via a second resistor, and an emitter of the transistor being grounded.

2. The control circuit as claimed in claim 1, wherein the control signal is a RS232 voltage signal.

3. A control circuit, comprising:
a relay supporting a transistor-transistor-logic (TTL) standard;
a diode having an anode and a cathode, the anode of the diode acting as an input for receiving a RS232 voltage signal; and
a transistor, a base of the transistor connected to the cathode of the diode via a first resistor, a collector of the transistor connected to an end of the relay, another end of the relay connected to a power supply via a second resistor, and an emitter of the transistor being grounded.
